(19) United States
(12) Patent Application Publication
(10) Pub. No.: US 2012/0141843 A1
(43) Pub. Date: Jun. 7, 2012

(54) BATTERY HAVING DIVERTING DEVICE

(75) Inventors: Andreas Gutsch, Luedinghausen (DE); Tim Schaefer, Niedersachswerfen (DE)

(73) Assignee: LI-TEC BATTERY GmbH, Kamenz (DE)

(21) Appl. No.: 13/202,686

(22) PCT Filed: Feb. 12, 2010
(86) PCT No.: PCT/EP2010/000884

§ 371 Date: Feb. 17, 2012

(30) Foreign Application Priority Data
Feb. 23, 2009 (DE) 10 2009 010 145.4
Oct. 14, 2009 (EP) 09012980.0

(51) Int. Cl. H01M 10/50; H01M 10/02; H01M 10/48

(52) U.S. Cl. 429/50; 429/120; 429/90; 429/72

(57) ABSTRACT

An electrochemical energy accumulator apparatus according to the invention has at least one galvanic cell. Furthermore, the electrochemical energy accumulator apparatus has at least one diverting device which is assigned to the at least one galvanic cell, and at least one connecting device which is assigned to the at least one diverting device. The electrochemical energy accumulator apparatus is characterized in that the at least one connecting device is assigned at least one heat exchanger device, wherein the at least one heat exchanger device is designed to exchange thermal energy with the at least one connecting device.

Priority application DE 10 2009 010 145.4 is fully incorporated by reference into the present application.

The present invention relates to a battery having at least one diverting device. The invention is described in connection with rechargeable lithium-ion batteries for powering motor vehicle drives. It is to be noted that the invention can also be used independently of the construction of the battery or its galvanic cells, its chemistry, and also independently of the type of the powered drive.

Rechargeable batteries having multiple galvanic cells for powering motor vehicle drives are known from the prior art. Their galvanic cells age during the operation of such a battery, so that the charging capacity of the galvanic cells or the battery is increasingly reduced.

The invention is therefore based on the object of maintaining the charging capacity of the galvanic cells of a battery during a high number of charging cycles.

This object is achieved according to the invention by the subjects of the independent claims. Preferred refinements of the invention are the subject matter of the subclaims.

An electrochemical energy storage device according to the invention comprises at least one galvanic cell. Furthermore, the electrochemical energy storage device comprises at least one diverting device, which is associated with the at least one galvanic cell, and at least one junction device, which is associated with the at least one diverting device. The electrochemical energy storage device is characterized in that at least one heat exchanger device is associated with the at least one junction device. The at least one heat exchanger device is designed to exchange thermal energy with the at least one connection device.

As defined in the invention, an electrochemical energy storage device is to be understood as a device which also comprises at least one galvanic cell. The device also comprises further devices, which serve to operate the at least one galvanic cell. The at least one galvanic cell and the supplementary devices can be situated in a common housing. The electrochemical energy storage device can also comprise multiple units beyond a certain number of galvanic cells.

As defined in the invention, a galvanic cell is to be understood as a device which also serves to discharge electrical energy and to convert chemical energy into electrical energy. For this purpose, the galvanic cell has at least two electrodes of different polarity and the electrolyte. Depending on the construction, the galvanic cell is also capable of absorbing electrical energy during charging, converting it into chemical energy, and storing it. The conversion of electrical energy into chemical energy is subject to losses and is accompanied by irreversible chemical reactions. An electrical current into or out of a galvanic cell can cause electrical heating power. This electrical heating power can result in a temperature increase of the galvanic cell. Irreversible chemical reactions increase with rising temperature. These irreversible chemical reactions can have the effect that areas of a galvanic cell are no longer available for the conversion and/or storage of energy. With an increasing number of charging procedures, these areas increase in extent. The usable charging capacity of a galvanic cell or the device thus decreases.

As defined in the invention, a diverting device is to be understood as a device which conducts electrons out of a galvanic cell in the direction of an electrical consumer during discharge. The at least one diverting device is preferably associated with one of the electrodes of the galvanic cell, in particular electrically conductively connected to this electrode. A diverting device also allows a current flow in the opposite direction. The at least one diverting device is preferably also connected to a galvanic cell to conduct heat. In the case of a corresponding temperature gradient, a diverting device as defined in the invention also performs a transport of thermal energy out of a galvanic cell. The diverting device preferably comprises a metal. The diverting device particularly preferably comprises copper or aluminum.

As defined in the invention, the at least one diverting device is also to be understood as a unit made of multiple diverting devices of various galvanic cells, which are connected by means of a current-conducting connecting device, for example. The galvanic cells are connected in a series or parallel circuit, preferably by means of multiple provided current-conducting connecting devices. With such an implementation of the device according to the invention, the at least one junction device is connected to the at least one current-conducting connecting device of the diverting device to conduct electricity and heat. A current-conducting connecting device is preferably designed so that its heat resistance does not exceed a predetermined value.

As defined in the invention, a junction device is to be understood as a device which also supplies electrons from a diverting device to an electrical consumer. A junction device can also act in the opposing current direction. The junction device is preferably implemented as rigid. A junction device is preferably implemented as movable, as a power cable or conductor line. In particular if movements or vibrations are to be expected during the operation of the junction device, the at least one junction device is preferably implemented as movable. The conductor line can be implemented as a film line, lamellae line, or wire line. The construction of the junction device is also dependent on the structural conditions at the usage location and the strains to be expected during operation of the electrochemical energy storage device. The junction device is preferably screwed or riveted to the at least one diverting device. However, other types of the connection are also possible.

As defined in the invention, a heat exchanger device is to be understood as a device which also dissipates thermal energy from the junction device. The orientation of the heat flow is a function of the temperature gradient between the heat exchanger device and the junction device or the galvanic cells of the electrochemical energy storage device. The heat exchanger device preferably comprises a material having high thermal conductivity, in particular copper or aluminum. A main body of a heat exchanger device preferably has a minimum heat capacity. Extensions to enlarge the surface are preferably situated on the lateral surface of the main body of the heat exchanger device, preferably ribs or fins having arbitrary cross-sectional surface. An extension preferably tapers with increasing distance from the main body.

The at least one heat exchanger device is preferably implemented as multipart. A heat exchanger device preferably at least partially encloses a junction device.

The at least one heat exchanger device preferably counteracts a temperature increase of a galvanic cell.

A part of the heating power which is produced by an electrical current into or out of the galvanic cell is preferably dissipated by the at least one heat exchanger device.

The electrical heating power of an electrical current, which is supplied to or discharged from the at least one galvanic cell, is preferably at least temporarily less than the heating power which the at least one heat exchanger device withdraws.

The dissipation of a heating power from a galvanic cell with the aid of a heat exchanger device according to the invention is performed indirectly via heat-conducting bodies, in particular diverting device and junction device, which are situated between the galvanic cell and the heat exchanger device according to the invention. Each of these bodies represents a thermal resistance, which counteracts the driving temperature difference of the temperature of the galvanic cell and the temperature of the heat exchanger device. If heating power is withdrawn from a galvanic cell by means of the heat exchanger device, the temperature drops along the section between the galvanic cell and the heat exchanger device. The permissible operating temperatures of a galvanic cell thus deviate from those of the heat exchanger device. The permissible operating temperatures of a heat exchanger device are preferably determined by means of a heat flow balance. The maximum permissible operating temperature of a heat exchanger device is preferably lower than the maximum permissible operating temperature of a galvanic cell connected thereto to conduct heat.

If the temperature of the heat exchanger device is less than the temperature of the at least one galvanic cell, a heat flow is generated from the galvanic cell in the direction of the heat exchanger device. The temperature in the galvanic cell can thus be reduced. Irreversible chemical reactions are thus decreased. The areas of the galvanic cell serving for energy conversion and energy storage are substantially maintained. The progressive aging of the galvanic cells of a battery is thus decreased, the charging capacity is maintained over a longer period of time, and the fundamental object is achieved.

Preferred refinements of the invention are described hereafter.

The at least one heat exchanger device advantageously comprises at least one first surface area and one second surface area. The surface areas are situated on at least one lateral surface of the at least one heat exchanger device. The at least one heat exchanger device is preferably electrically insulated in relation to the at least one junction device. A first surface area can thus in particular have an electrically insulating coating. The quotient of the area content of a first surface area and the area content of a second surface area is preferably less than 0.9. This quotient is preferably less than 0.4. This quotient is particularly preferably less than 0.05. The lower limit of the quotient is determined from economic considerations and is also a function of the available space.

The at least one heat exchanger device advantageously has at least one measuring device. The at least one measuring device preferably detects the temperature of a heat exchanger device. The at least one measuring device preferably detects the temperature in spatial proximity to a second surface area of the at least one heat exchanger device. The at least one measuring device particularly preferably ascertains the temperature of a second surface area of the at least one heat exchanger device.

A measuring device preferably comprises multiple measuring probes, which are in particular associated with various heat exchanger devices. The at least one measuring device preferably at least temporarily provides a measured value which can be processed by a control unit supplementing a device according to the invention.

A first fluid advantageously at least temporarily flows against the heat exchanger device. The difference of the temperature of the first fluid and the temperature of the at least one heat exchanger device, the so-called temperature difference, also determines the orientation of a heat flow. The cooling power of the first fluid is preferably set by means of adaptation of the temperature difference and the mass flow rate.

The first fluid is preferably ambient air.

The at least one heat exchanger device advantageously comprises at least one first fluid channel. This first fluid channel at least temporarily has a first fluid having specific temperature and flow speed flowing through it. The first fluid is preferably ambient air or another coolant. A first fluid channel is preferably situated in spatial proximity to a first surface area inside a heat exchanger device. The at least one heat exchanger device preferably comprises multiple first fluid channels.

A conveyor device is advantageously associated with the electrochemical energy storage device. This conveyor device preferably serves to convey the first fluid, in particular to cool the heat exchanger device. The conveyor performance of the conveyor device is also adapted to the heating power to be transferred. The conveyor device is preferably switched by a control unit, which supplements a device according to the invention. The conveyor device is preferably supplied with energy by the electrochemical energy storage device. The conveyor device is preferably a fan or a pump for a coolant.

The heat exchanger device advantageously comprises a first material, which is provided to pass through a phase transition in the case of predefined conditions. A first material is preferably selected so that its phase transition temperatures are between the maximum permissible operating temperature of the at least one heat exchanger device and the minimum operating temperature thereof. A first material is particularly preferably selected so that its phase transition temperatures are only a few degrees Kelvin below the maximum permissible operating temperature of the at least one heat exchanger device.

The maximum permissible operating temperature of the at least one heat exchanger device is also a function of the maximum permissible operating temperature of a galvanic cell connected thereto to conduct heat.

The heat exchanger device preferably further comprises a further first material. A further first material is particularly preferably selected so that its phase transition temperatures are only a few degrees Kelvin above the minimum operating temperature of the at least one heat exchanger device.

A first material is preferably situated in a cavity of the at least one heat exchanger device. A first material is preferably situated in a so-called “heat pipe”. This heat pipe is inserted into a heat exchanger device so that the end of the heat pipe which absorbs heat is close to the first surface area. The end of the heat pipe which discharges heat is located close to the second surface area or protrudes out of the heat exchanger device.

The at least one heat exchanger device is advantageously electrically heated, in particular using a resistance heater. In particular after a cold start, the at least one heat exchanger device can serve to supply thermal energy to the indirectly thermally connected galvanic cells. A resistance heater is preferably powered by the electrochemical energy storage device.

The at least one heat exchanger device is advantageously electrically cooled. At least one Peltier element serves for this purpose in particular, which is preferably powered by the electrochemical energy storage device.

A motor vehicle is advantageously equipped with an electrochemical energy storage device according to the invention. Furthermore, the motor vehicle comprises an air conditioner. The coolant of the air conditioner flows through the at least one first fluid channel of the at least one heat exchanger device in particular as needed.

A valve for limiting the coolant flow through the at least one fluid channel is preferably associated with the heat exchanger device.

The electrochemical energy storage device is advantageously operated so that a first fluid at least temporarily flows against the at least one heat exchanger device. The temperature and the flow rate of the first fluid are selected as a function of the heating power to be transferred. Both the temperature and also the mass flow rate of the first fluid can vary over time.

The electrochemical energy storage device is advantageously operated so that the at least one first fluid channel of the at least one heat exchanger device temporarily has a first fluid flowing through it. Temperature and mass flow rate of the first fluid are adapted to the heating power to be transferred.

The electrochemical energy storage device is advantageously operated so that the conveyor device associated therewith is switched in the case of predetermined conditions. The conveyor device is preferably switched on or off upon exceeding or falling below a predefined temperature of the at least one heat exchanger device.

The temperature of the at least one heat exchanger device is preferably detected by the at least one measuring device, in particular by a thermocouple. A control unit which supplements the device preferably processes the value provided by the at least one measuring device and switches the conveyor device.

The at least one heat exchanger device of the electrochemical energy storage device is advantageously electrically heated or cooled as needed. For this purpose, the signal of the at least one measuring device is preferably processed by a control unit which supplements the device.

The electrochemical energy storage device is advantageously operated with a motor vehicle having an air conditioner in such a manner that a coolant of the air conditioner is used for the temperature control of the at least one heat exchanger device. The coolant flow rate is set as a function of the heating power to be transferred. The temperature difference between coolant and the at least one heat exchanger device is preferably also considered.

The electrochemical energy storage device is advantageously operated so that the heat exchanger device supplies thermal energy to the at least one junction device. For this purpose, the temperature of the heat exchanger device is higher than the temperature of the junction device. This thermal energy is indirectly supplied to the at least one galvanic cell and the temperature thereof is increased. This is also advantageous in particular during a cold start to increase the energy discharge of the electrochemical energy storage device.

At least one electrode of the electrochemical energy storage device, particularly preferably at least one cathode, preferably comprises a compound having the formula LiMPO₄, M being at least one transition metal of the first row of the periodic table of the elements. The transition metal cation is preferably selected from the group comprising Mn, Fe, Ni, and Ti or a combination of these elements. The compound preferably has an olivine structure, preferably higher-order olivine.

In a further embodiment, at least one electrode of the electrochemical energy storage device, particularly preferably at least one cathode, preferably comprises a lithium manganate, preferably LiMn₂O₄ of the spinel type, a lithium cobaltate, preferably LiCoO₂, or a lithium nickelate, preferably LiNiO₂, or a mixture of two or three of these oxides, or a lithium mixed oxide, which contains manganese, cobalt, and nickel.

The negative electrode and the positive electrode of the electrochemical energy storage device are preferably separated from one another by one or more separators. Such separator materials can also comprise porous inorganic materials which are composed so that a material transport can occur through the separator perpendicular to the separator layer, for example, while in contrast a material transport parallel to the separator layer is obstructed or even suppressed.

Separator materials which comprise a porous inorganic material which is permeated with particles or has such particles at least on its surface, which melt upon reaching or exceeding a temperature threshold and at least locally shrink or close the pores of the separator layer, are particularly preferred. Such particles can preferably comprise a material which is selected from a group of materials, which comprises polymers or mixtures of polymers, waxes, or mixtures of these materials.

An embodiment of the invention is particularly preferred in which the separator layer is designed in such a manner that its pores fill with the mobile component, which participates as an educt in the chemical reaction, because of a capillary action, so that only a relatively small part of the total amount of the mobile component provided in the electrochemical energy storage device is located outside the pores of the separator layer. In this context, the electrolyte located in the electrochemical energy storage device or one of its chemical components or a mixture of such components is a particularly preferred educt, which wets or impregnates the entire porous separator layer, but is not to be encountered or is to be encountered only in negligible or comparatively small quantities outside the separator layer, according to a particularly preferred exemplary embodiment of the invention. Such an arrangement can be obtained during the production of the electrochemical energy storage device in that the porous separator is impregnated with the electrolyte located in the electrochemical energy storage device or another educt of a suitable selected chemical reaction, so that this educt is subsequently substantially located only in the separator.

If a pressure increase, which is possibly initially only local, occurs because of a chemical reaction through formation of a gas bubble or through local heating, this educt cannot flow out of other areas into the reaction region. To the extent or as long as it can still flow in, the availability of this educt is reduced accordingly at other points. The reaction finally comes to a standstill or at least remains limited to a preferably small region.

A separator, which does not conduct or only poorly conducts electrons, and which comprises an at least partially material-permeable carrier, is preferably used according to the invention. The carrier is preferably coated on at least one side using an inorganic material. Preferably, an organic material is used as the at least partially material-permeable carrier, which is preferably designed as a nonwoven fleece. The organic material, which preferably comprises a polymer and particularly preferably a polyethylene terephthalate (PET), is coated using an inorganic, preferably ion-conducting material, which is more preferably ion-conducting in a temperature range from −40° C. to 200° C. The inorganic material preferably comprises at least one compound from the group of oxides, phosphates, sulfates, titanates, silicates, aluminosilicates with at least one of the elements Zr, Al, Li, particularly preferably zirconium oxide. The inorganic, ion-conducting material preferably comprises particles having a largest diameter less than 100 nm.

Such a separator is sold, for example, under the trade name “Separion” by Evonik AG in Germany.

Further advantages, features, and possible applications of the present invention result from the following description in connection with the figures. In the figures:

FIG. 1 shows a schematic view of an electrochemical energy storage device according to the invention having multiple galvanic cells,

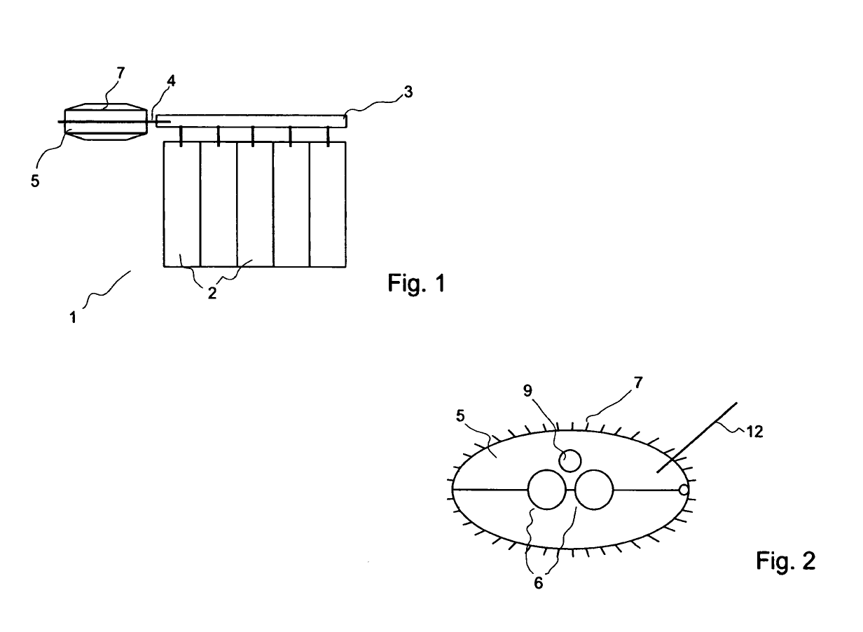

FIG. 2 shows a multipart heat exchanger device according to the invention having fluid channel and thermocouple in section,

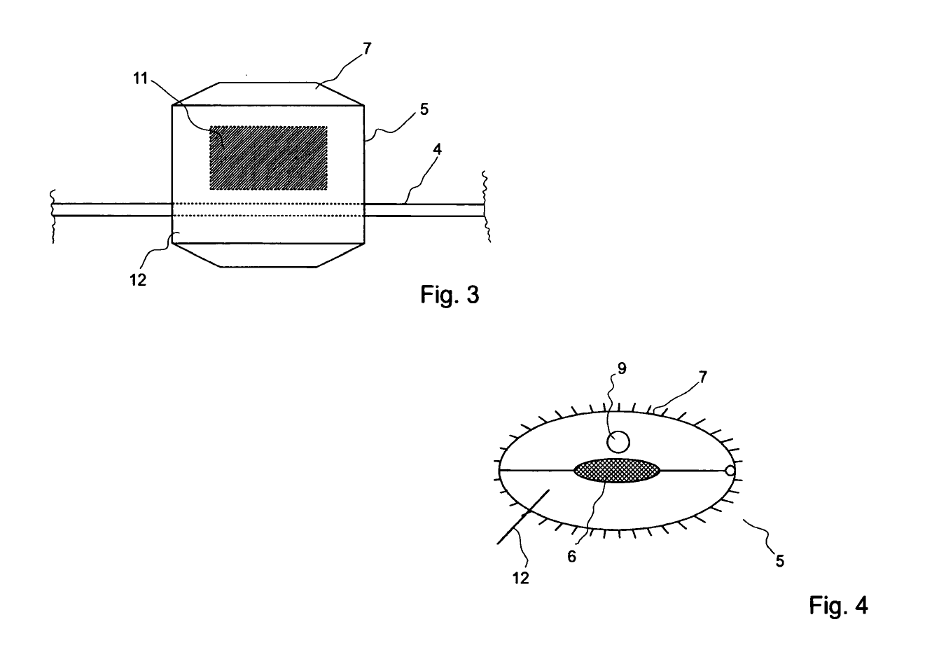

FIG. 3 shows a heat exchanger device according to the invention having a first material, which is situated in a cavity, and resistance heater,

FIG. 4 shows a heat exchanger device according to the invention, designed for a flat cable,

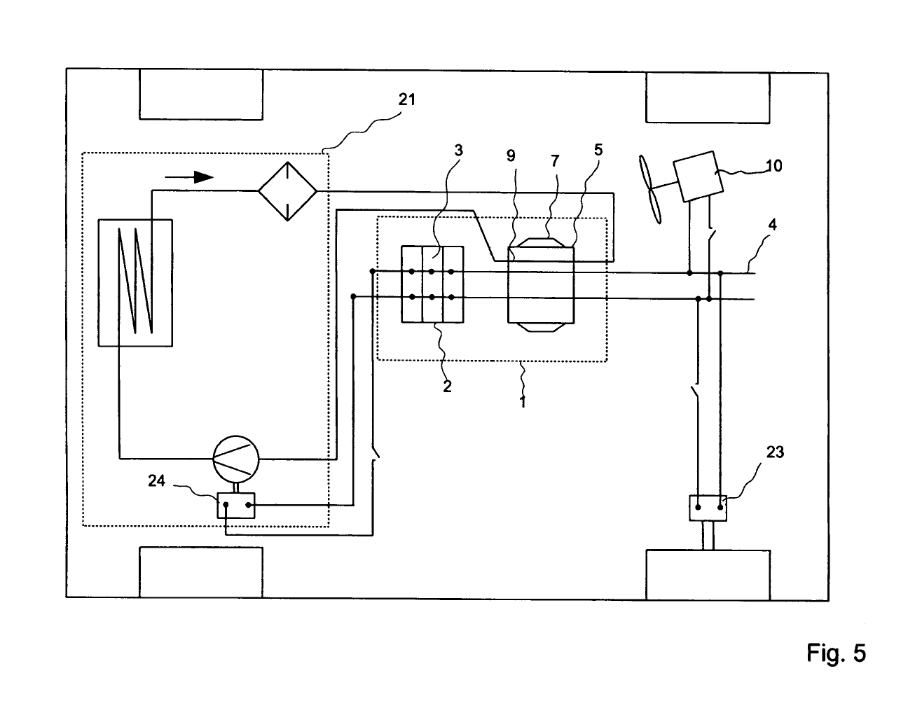

FIG. 5 shows an electrochemical energy storage device according to the invention having a heat exchanger device which is cooled by the air conditioner of a motor vehicle.

FIG. 1 shows an electrochemical energy storage device 1 according to the invention having multiple galvanic cells 2. The galvanic cells 2 are connected to a current-conducting connection device of a common diverting device 3 to conduct electricity and heat. The galvanic cells 2 are thus connected in parallel. The galvanic cells 2 can also be connected in series. Combinations of series and parallel circuits are also possible. A junction cable 4 is connected to the current-conducting connection device of the common diverter 3. Diverters and cables for the electrical contacting of the electrodes of opposing polarity of the galvanic cells are not shown. The junction cable 4 leads to an electrical consumer. A heat exchanger device 5 is associated with the junction cable 4 close to the diverter 3. The heat exchanger device 5 contacts the junction cable 4 to conduct heat. The heat exchanger device 5 comprises ribs to enlarge the second surface area 7, only two ribs being shown. The heat exchanger device 5 encloses the junction cable 4 and is situated in direct proximity to the connection of diverter 3 and junction cable 4. Influence can also be taken on the thermal resistance with respect to the heating power to be dissipated using the arrangement of the heat exchanger device 5. Thus, a heat exchanger device at a greater distance from the diverter or from the galvanic cells can be of less use for the transfer of heating power from the galvanic cells of an energy storage device according to the invention.

FIG. 2 shows a heat exchanger device 5 in section. The heat exchanger device 5 is implemented in two parts. The two halves of the heat exchanger device 5 are connected using a hinge, which is indicated on the right side. The heat exchanger device 5 comprises two first surface areas 6, which are provided for the heat-conducting contact of the junction cable (not shown). The second surface area 7 of the heat exchanger device 5 comprises cooling ribs. Furthermore, one half of the two-part heat exchanger device 5 comprises a first fluid channel 9. The heat exchanger device 5 is also equipped with a thermocouple 12. In the two-part heat exchanger device 5, two junction cables 4 can be inserted after it is folded open. The recesses for the junction cables 4 are implemented so that press-fits result after the closing of the halves. A good thermal contact is thus ensured between the junction cables 4 and the first surface areas 6. A closing device, which prevents unintentional opening of the halves, is not shown.

FIG. 3 shows a heat exchanger device 5 according to the invention, which regionally encloses a junction cable 4. The second surface area 7 of the heat exchanger device 5 comprises ribs, two of which are shown in the figure. Furthermore, the heat exchanger device 5 comprises a cavity having a first material 11. This first material is selected so that its melting temperature is 2° Kelvin below the maximum permissible operating temperature for the heat exchanger device 5. The maximum permissible operating temperature of the heat exchanger device 5 is selected so that the temperature difference between an indirectly connected galvanic cell 2 and the heat exchanger device 5 allows the withdrawal of a part of the heating power which is caused by an electrical current into the galvanic cell 2 or out of a galvanic cell 2. The maximum permissible operating temperature of the heat exchanger device 5 is thus also a function of the total heat resistance of the heat conducting bodies between a galvanic cell 2 and a thermally connected heat exchanger device 5. Furthermore, the heat exchanger device 5 comprises a thermocouple 12, which is situated close to the second surface area 7.

FIG. 4 shows a further heat exchanger device 5 according to the invention. It is designed to enclose a current line 4. The geometry of the first surface area 6 is adapted to the form of the current line 4. The current line 4 is received by the heat exchanger device 5 by means of a press fit.

FIG. 5 shows a motor vehicle having an air conditioner 21 and an electrochemical energy storage device according to the invention. The air conditioner 21 is only shown to the extent which is necessary to explain the function of the electrochemical energy storage device 1. The electrochemical energy storage device 1 comprises a number of galvanic cells 2. These are connected in parallel to a current-conducting connection device of a common diverting device 3. A junction device 4 is connected to the diverting device 3. The junction device 4 runs through a heat exchanger device 5, whose second surface area 7 comprises ribs. The heat exchanger device 5 simultaneously receives two junction cables 4. Various supply lines to various consumers branch off of the junction cable 4. In particular, an electric motor 23 for driving a wheel of the vehicle, a first conveyor device 10, and the drive 24 for the coolant pump of the air conditioner 21 are shown.

The energy storage device 1 is operated so that even before reaching a maximum permissible operating temperature of a galvanic cell 2 or the heat exchanger device 5, the conveyor device 10 and the coolant pump 24 are turned on. The conveyor device 10 causes an airflow which flows against the second surface area 7. The coolant pump 24 conveys the coolant 22 of the air conditioner 21. The coolant 22 flows through a first fluid channel 9 and thus also contributes to cooling the heat exchanger device 5. A temperature difference between the heat exchanger device 5 and the galvanic cell 2 indirectly connected thereto can thus be generated and heating power can be withdrawn from the galvanic cell 2 or the heat exchanger device 5.

1. An electrochemical energy storage device, which comprises:
at least one galvanic cell,
at least one diverting device, which is associated with the at least one galvanic cell,
at least one junction device, which is associated with the at least one diverting device,
wherein at least one heat exchanger device is associated with the at least one junction device,
the at least one heat exchanger device being designed to exchange thermal energy with the at least one junction device.

2. The electrochemical energy storage device according to claim 1, wherein
the at least one heat exchanger device comprises a first surface area and a second surface area,
the first surface area being at least partially designed for in particular heat-conducting contact with the at least one junction device,
and an area content of the first surface area not being greater than an area content of the second surface area.

3. The electrochemical energy storage device according to claim 1, further comprising:
at least one measuring device, in particular at least one temperature measuring device, associated with the at least one heat exchanger device.

4. The electrochemical energy storage device according to claim 1, wherein the at least one heat exchanger device, in particular the second surface area of the at least one heat exchanger device, is provided to have a first fluid flow against it.

5. The electrochemical energy storage device according to claim 1, wherein the at least one heat exchanger device comprises at least one first fluid channel, which is provided to have a first fluid flow through it.

6. The electrochemical energy storage device according to claim 1, further comprising:
a conveyor device, in particular for conveying a first fluid, associated with the electrochemical energy storage device.

7. The electrochemical energy storage device according to claim 1, wherein the at least one heat exchanger device comprises at least one first material, which is provided to pass through a phase transition in the case of predefined conditions,
the temperature of a phase transition of the first material being adapted to the operating temperature of the at least one heat exchanger device.

8. The electrochemical energy storage device according to claim 1, wherein the heat exchanger device is designed to be electrically heated or cooled.

9. The electrochemical energy storage device according to claim 1, further comprising:
at least one electrode, preferably a cathode, which comprises a compound having the formula LiMPO4, M being at least one transition metal cation of the first row of the periodic table of the elements, this transition metal cation preferably being selected from the group consisting of Mn, Fe, Ni, and Ti or a combination of these elements, and the compound preferably having an olivine structure, preferably higher-order olivine, Fe being particularly preferred; and/or it comprises at least one electrode, preferably at least one cathode, which comprises a lithium manganate, preferably LiMn2O4 of the spinel type, a lithium cobaltate, preferably LiCoO2, or a lithium nickelate, preferably LiNiO2, or a mixture of two or three of these oxides, or a lithium mixed oxide, which contains manganese, cobalt, and nickel.

10. The electrochemical energy storage device according to claim 1, further comprising:
at least one separator, which conducts electrons poorly or not at all, and which consists of an at least partially material-permeable carrier, the carrier preferably being coated on at least one side using an inorganic material,
an organic material preferably being used as the at least partially material-permeable carrier, which is preferably designed as a nonwoven fleece, the organic material preferably comprising a polymer and particularly preferably a polyethylene terephthalate (PET),
the organic material being coated using an inorganic, preferably ion-conducting material, which is more preferably ion-conducting in a temperature range from −40° C. to 200° C., the inorganic material preferably comprising at least one compound from the group of oxides, phosphates, sulfates, titanates, silicates, aluminosilicates with at least one of the elements Zr, Al, Li, particularly preferably zirconium oxide, the inorganic, ion-conducting material preferably comprising particles having a greatest diameter less than 100 nm.

11. A motor vehicle having an electrochemical energy storage device according to claim 1 and having an air conditioner, wherein the at least one heat exchanger device, in particular the at least one first fluid channel of the at least one heat exchanger device, is provided to have a coolant of the air conditioner flow through it,
the air conditioner being connected to the at least one heat exchanger device, in particular to the at least one fluid channel of the at least one heat exchanger device, preferably via at least one movable pipeline.

12. A method for operating a device according to claim 4, wherein the at least one heat exchanger device, in particular the second surface area of the at least one heat exchanger device, has a first fluid flowing against it in the case of predefined conditions.

13. A method for operating a device according to claim 5, wherein the at least one first fluid channel of the at least one heat exchanger device has a first fluid flowing through it.

14. A method for operating a device according to claim 6, wherein the conveyor device is switched in the case of predetermined conditions.

15. A method for operating a device according to claim 8, wherein the at least one heat exchanger device is electrically heated or cooled in the case of predetermined conditions.

16. A method for operating a device according to claim 12, wherein the at least one first fluid channel of the at least one heat exchanger device has a coolant of the air conditioner flowing through it, the coolant stream being set as a function of the heating power to be transferred.
